(19) United States
(12) Patent Application Publication
(10) Pub. No.: US 2005/0140864 A1
(43) Pub. Date: Jun. 30, 2005

(54) Liquid crystal display

(75) Inventors: Mitsuyoshi Miyai, Osaka (JP); Jun Yamada, Osaka (JP); Masakazu Okada, Kyoto-shi (JP); Keiichi Furukawa, Tokyo (JP); Tomoo Izumi, Osaka (JP)

Correspondence Address: BRINKS HOFER GILSON & LIONE, P.O. BOX 10395, CHICAGO, IL, 60610, US

(73) Assignee: KONICA MINOLTA HOLDINGS, INC.

(21) Appl. No.: 11/018,981

(22) Filed: Dec. 21, 2004

(30) Foreign Application Priority Data
Dec. 25, 2003 (JP) 2003-429971

(51) Int. Cl. G02F 1/1335; C09K 19/02

(52) U.S. Cl. 349/113; 349/176

(57) ABSTRACT

A liquid crystal display apparatus having a circular polarizer (composed of a linear polarizer and a retardation film), a scattering layer and a liquid crystal display which are stacked one upon another. The liquid crystal display has a chiral nematic liquid crystal layer between substrates, and electrodes and aligning layers are provided on mutually opposite surfaces of the substrates. The chiral nematic liquid crystal changes between a planar state and a focal-conic state in accordance with a voltage applied thereto through the electrodes. When the liquid crystal is in a planar state, light reflected by the electrode formed on the substrate located farther from an observing side is absorbed in the circular polarizer, and a black display is made. When the liquid crystal is in a focal-conic state, light reflected by the electrode formed on the substrate located farther from the observing side passes through the circular polarizer, and a white display is made. In this moment, the light reflected by the electrode is scattered by a scattering layer, and the directivity of the reflected light is weakened.

This application is based on Japanese patent application No. 2003-429971 filed on Dec. 25, 2003, of which content is herein incorporated by reference.

### BACKGROUND OF THE INVENTION

1. Field of the Invention

The present invention relates to a liquid crystal display, and more particularly to a liquid crystal display using cholestric liquid crystal as a display medium.

2. Description of Related Art

In recent years, applications of reflective-type liquid crystal displays to display devices of mobile telephones and mobile personal computers are studied and developed. Reflective-type liquid crystal displays make displays by reflecting circumferential light (external light) and therefore have advantages of consuming little electric power, of being thin and light, etc.

Generally, reflective-type liquid crystal displays used at present comprise nematic liquid crystal and are driven in a TN (twisted nematic) mode or an STN (super twisted nematic) mode. These reflective-type liquid crystal displays comprising nematic liquid crystal, however, do not have a memory effect and accordingly consume electric power all the time they display images thereon, although these reflective-type liquid crystal displays consume less electric power than transmitting-type liquid crystal displays.

Meanwhile, reflective-type liquid crystal displays with a memory effect have been developed because these liquid crystal displays are expected to contribute to further power-saving. These reflective-type liquid crystal displays typically comprise cholestric liquid crystal. The cholestric liquid crystal is bistable, that is, turns into a planar state or into a focal-conic state depending on a voltage applied thereto and keeps in the respective states (has a memory effect). Moreover, the cholestric liquid crystal has the following characteristics:
1) the cholestric liquid crystal, when it is in a planar state, reflects only light of a specified wavelength selected from incident rays, and when it is in a focal-conic state, substantially does not reflect incident rays; and
2) the cholestric liquid crystal, when it is in a focal-conic state, exhibits anisotropy of refractive index, and when it is in a planar state, does not exhibit anisotropy of refractive index.

A prior art, SID International Symposium Digest of Technical Paper, Volume 29, 1998, page 897 discloses a display making use of the characteristic of selective reflection (characteristic 1). The liquid crystal display has three cholestric liquid crystal layers stacked one upon another, and the liquid crystal layers selectively reflect R, G and B respectively. Thereby, the liquid crystal display achieves a good white display on a black background. However, since this display comprises three liquid crystal layers, it is thick and heavy and also costly.

U.S. Pat. No. 6,462,805 and Japanese Patent Laid-Open Publication No. 2003-149682 disclose liquid crystal displays making use of the characteristic of anisotropy of refractive index (characteristic 2). These liquid crystal displays are of a structure which has a cholesteric liquid crystal layer between a circular polarizer and a reflecting plate. The liquid crystal displays white when it is in a focal-conic state, and displays black when it is in a planar state. In these liquid crystal displays, a white display can be made with a single cholesteric liquid crystal layer, and the liquid crystal displays are, therefore, thin and light and also less costly compared with the display making use of the characteristic of selective reflection.

The reflecting plates of these conventional liquid crystal displays making use of the characteristic of anisotropy of refractive index are made of metal, such as aluminum or silver, and the directivity of reflected light is strong. Due to the strong directivity of reflected light, a good white display, that is, paper white cannot be achieved. If a material with a weak directivity, such as barium nitrate, is used for the reflecting plate, the reflecting plate will offset the polarization made by the circular polarizer, and the contrast will be lower, resulting in remarkable degradation of display. For this reason, conventionally, metal which does not offset the polarization made by the circular polarizer has been used for the reflecting plate, and the task of achieving a good white display has been put aside.

### SUMMARY OF THE INVENTION

An object of the present invention is to provide a reflective-type liquid crystal display which can make a good white display without lowering the contrast.

In order to achieve the object, a first aspect of the present invention relates to a reflective-type liquid crystal display apparatus wherein a polarizer, a cholesteric liquid crystal layer which changes between a planar state and a focal-conic state depending on a voltage applied thereto, and a reflecting plate are stacked one upon another, and the liquid crystal display apparatus further comprises a scattering layer.

In the liquid crystal display apparatus according to the first aspect of the present invention, by changing the cholesteric liquid crystal layer between a planar state and a focal-conic state, the polarization of light which has passed through the polarizer is changed, and the quantity of light which is reflected by the reflecting plate and then enters into the polarizer again can be controlled. In this way, a display is made. Further, since the liquid crystal display apparatus comprises a scattering layer, the directivity of the reflected light is weakened, and a good white display (paper white) can be achieved when the liquid crystal is in a focal-conic state. Also, the scattering layer does not offset the polarization, and a lowering of contrast is not caused.

In the liquid crystal display apparatus according to the first aspect of the present invention, optimization of the haze of the scattering layer and optimization of the position of the scattering layer are important. Specifically, the haze of the scattering layer is desirably within a range from 10% to 85%, more desirably within a range from 30% to 85%, and further more desirably within a range from 30% to 70%.

The polarizer is composed of a linear polarizer and a retardation film, and the scattering layer is preferably located on a lower surface of the polarizer. Further, it is also preferred that the distance between the scattering layer and the cholesteric liquid crystal layer is 0.5 mm or less. This small distance between the scattering layer and the cholesteric liquid crystal layer can be achieved in a structure wherein the cholesteric liquid crystal layer is supported between a pair of substrates and wherein the substrate located between the scattering layer and the liquid crystal layer is a film substrate.

In the structure wherein the cholesteric liquid crystal layer is supported between a pair of substrates, it is also possible to impart a scattering function to the substrate located closer to an observing side.

A liquid crystal display apparatus according to a second aspect of the present invention relates to a reflective-type liquid crystal display apparatus wherein a polarizer, a cholesteric liquid crystal layer which changes between a planar state and a focal-conic state depending on a voltage applied thereto, and a reflecting plate are stacked one upon another, and the reflecting plate has an uneven surface serving as a scattering reflecting surface.

In the liquid crystal display apparatus according to the second aspect of the present invention, because of the uneven surface of the reflecting plate, the directivity of light reflected by the reflecting plate is weakened, and a good white display (paper white) can be achieved when the liquid crystal is in a focal-conic state. Also, the uneven surface of the reflecting plate does not offset the polarization, and a lowering of contrast is not caused.

In the liquid crystal display apparatus according to the second aspect of the present invention, an electrode used to apply a voltage to the cholesteric liquid crystal layer may serve also as a reflecting plate.

### BRIEF DESCRIPTION OF THE DRAWINGS

This and other objects and features of the present invention will be apparent from the following description with reference to the accompanying drawings, in which:

FIG. 1 is a schematic view showing changes in arrangement of liquid crystal molecules used for a reflective-type liquid crystal display apparatus according to the present invention;

FIG. 2 is a perspective view showing the general structure of the liquid crystal display apparatus;

FIG. 3 is an illustration showing a display principle of the liquid crystal display apparatus when the liquid crystal is in a planar state;

FIG. 4 is an illustration showing a display principle of the liquid crystal display apparatus when the liquid crystal is in a focal-conic state;

FIG. 5 is a sectional view of a liquid crystal display apparatus according to a first embodiment;

FIG. 6 is a sectional view of a liquid crystal display apparatus according to a second embodiment;

FIG. 7 is a sectional view of a liquid crystal display apparatus according to a third embodiment; and

FIGS. 8a and 8b are illustrations showing scattering made by a scattering layer.

### DETAILED DESCRIPTION OF THE PREFERRED EMBODIMENTS

Embodiments of a reflective-type liquid crystal display are hereinafter described with reference to the accompanying drawings.

Optical Anisotropy of Chiral Nematic Liquid Crystal; See FIG. 1

Nematic liquid crystal which exhibits a cholesteric phase at room temperature is typically chiral nematic liquid crystal which can be obtained by adding a sufficient amount of chiral agent to nematic liquid crystal so as to make the liquid crystal exhibit a cholesteric phase.

A chiral agent is an additive which, when it is added to nematic liquid crystal, twists molecules of the nematic liquid crystal. By adding a chiral agent to nematic liquid crystal, the liquid crystal molecules form a helical structure with specified twist intervals, and thereby, the liquid crystal exhibits a cholesteric phase.

Chiral nematic liquid crystal of this kind supported and sandwiched by two substrates is divided into a plurality of domains. Referring to FIG. 1, the liquid crystal molecules in a domain D form helical structures with helical axes S in the same direction. The domain D of chiral nematic liquid crystal is regarded to be an indicatrix exhibiting optical anisotropy.

When the liquid crystal in the domain D is in a planar state, that is, when the helical axes S are perpendicular to the substrates, the refractive index of the domain D is isotropic. When the liquid crystal in the domain D is in a focal-conic state, that is, when the helical axes S are parallel to the substrates, the refractive index of the domain D is anisotropic. Thus, the refractive index of the domain D changes depending on whether the liquid crystal in the domain D is in a planar state or in a focal-conic state.

When the liquid crystal in the domain D is in a planar state, the refractive index of the domain D is isotropic, and incident rays pass through the domain D. When the liquid crystal in the domain D is in a focal-conic state, the refractive index of the domain D is anisotropic, and incident rays thereto are polarized by birefringence. By making use of the phenomenon, a black-and-white display can be made.

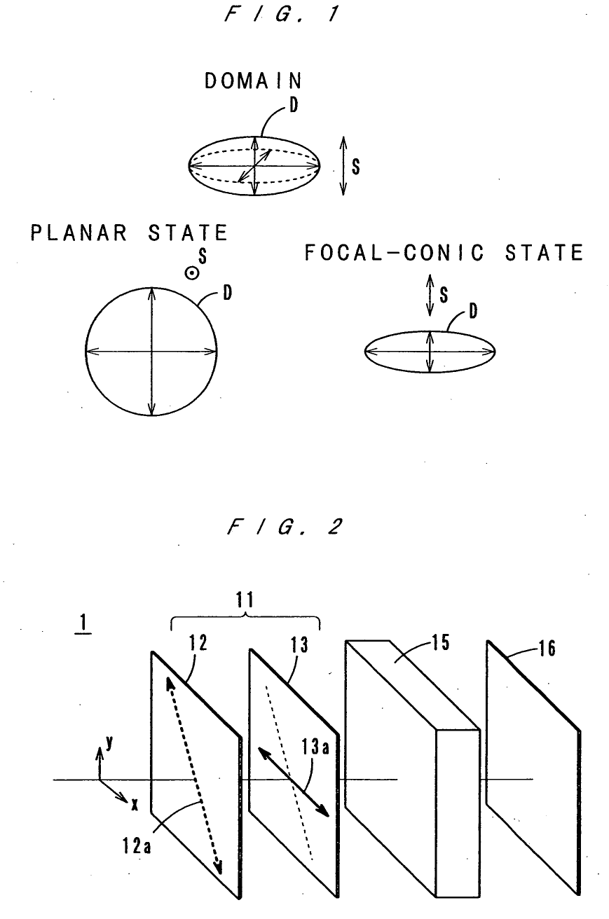

Basic Structure and Display Principle; See FIGS. 2-4

As FIG. 2 shows, a liquid crystal display apparatus 1 according to the present invention comprises a circular polarizer 11, a liquid crystal display 15 and a reflecting plate 16 stacked in this order from the observing side. The circular polarizer 11 is composed of a linear polarizer 12 with an absorption axis 12a and a quarter-wavelength retardation film 13 with a lag axis 13a.

The liquid crystal display 15 has chiral nematic liquid crystal between a pair of substrates with electrodes formed on mutually opposite surfaces. The chiral nematic liquid crystal meets the condition Δnd=(¼)λ when the liquid crystal is in a focal-conic state. The value Δnd is generally called retardation, and the unit is nm. An is the anisotropy of refractive index, and d is the gap between the substrates. The reflecting plate 16 is to reflect light which has passed through the liquid crystal layer and is made of aluminum, silver or the like.

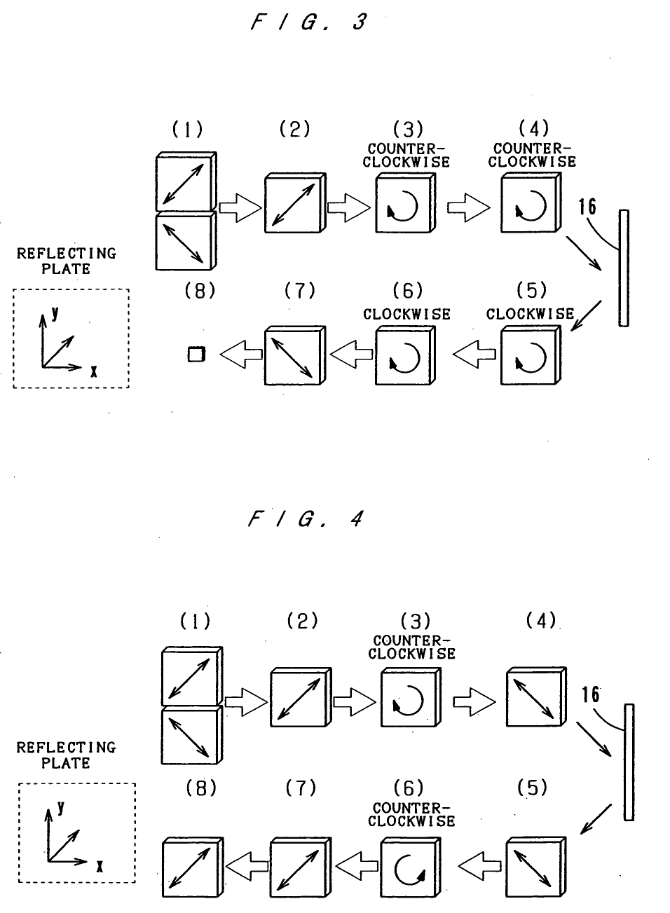

Fifty percent of incident rays to the circular polarizer 11 (composed of a linear polarizer 12 and a retardation film 13) is absorbed in the circular polarizer 11, and the other fifty percent is emergent from the circular polarizer 11 as circularly polarized (clockwise polarized or counterclockwise polarized) light (see (1) and (2) of FIG. 3, and (1) and (2) of FIG. 4).

When the domain of the chiral nematic liquid crystal is in a planar state, the circularly polarized light incident thereto passes through the liquid crystal layer without changing the state of polarization (see (3) and (4) of FIG. 3). The circularly polarized light which has passed through the liquid crystal layer is reflected by the reflecting plate 16. At this time, the traveling direction and also the direction of polarization of the circularly polarized light are reversed (see (5) of FIG. 3).

The reflected light passes through the liquid crystal layer (see (6) of FIG. 3) and enters into the circular polarizer 11 again. Since the light entering into the circular polarizer 11 again is circularly polarized in the reverse direction, the light is absorbed in the circular polarizer 11 (see (7) and (8) of FIG. 3). Thus, a black display is seen.

On the other hand, when the domain is in a focal-conic state, the circularly polarized light which has passed through the circular polarizer 11 turns into linearly polarized light under the influence of a quarter-wavelength retardation caused by birefringence, and the linearly polarized light passes through the liquid crystal layer (see (3) and (4) of FIG. 4). Thereafter, the linearly polarized light is reflected by the reflecting plate 16, and while passing through the liquid crystal layer, the linearly polarized light turns back into a circular polarized light under the influence of a quarter-wavelength retardation (see (5) and (6) of FIG. 4). The circularly polarized light passes through the circular polarizer 11 (see (7) and (8) of FIG. 4), and thus, a white display is seen.

FIGS. 3 and 4 schematically show the state of light in the following moments: (1) before entering into the circular polarizer; (2) immediately after passing through the linear polarizer; (3) immediately after passing through the retardation film; (4) immediately after passing through the liquid crystal layer; (5) immediately after being reflected by the reflecting plate 16; (6) immediately after passing through the liquid crystal layer again; (7) immediately after passing through the retardation film again; and (8) immediately after passing through the linear polarizer again.

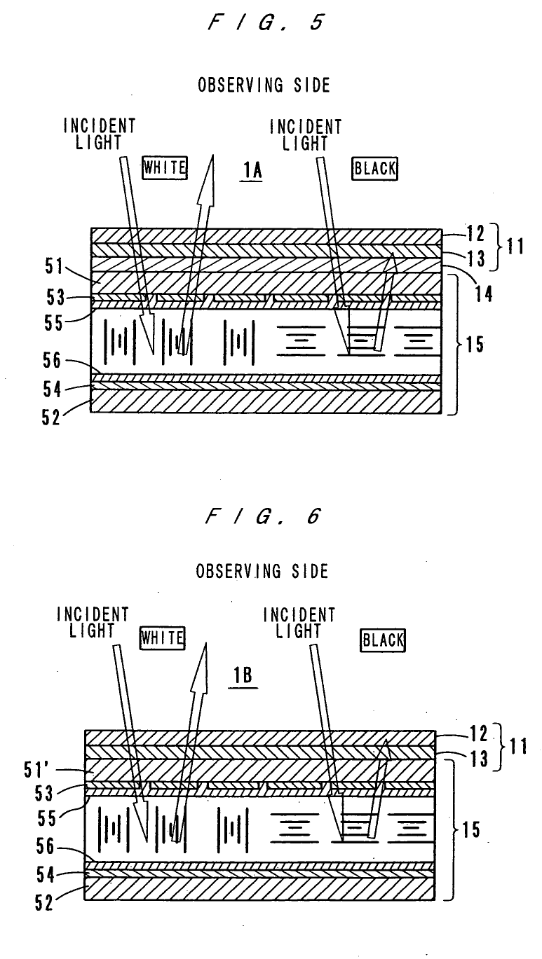

### First Embodiment; See FIG. 5

FIG. 5 shows a liquid crystal display apparatus 1A according to a first embodiment. The liquid crystal display apparatus 1A comprises a circular polarizer 11 (composed of a linear polarizer 12 and a retardation film 13), a scattering layer 14 and a liquid crystal display 15 which are stacked in this order from the observing side.

The liquid crystal display 15 has chiral nematic liquid crystal between substrates 51 and 52. The front substrate 51 (closer to the observing side) is made of a transparent material with a high light transmittance, and the back substrate 52 may be either transparent or opaque. As the materials of the substrates 51 and 52, thin glass plates, resin films of polyether sulfone (PES), polycarbonate (PC), polyethylene terephthalate (PET), etc. are usable, and on the mutually opposite surfaces of these plates or films, electrodes 53 and 54, and aligning layers 55 and 56 are formed. Additionally, insulating layers may be formed on the aligning layers 55 and 56. Although the aligning layers 55 and 56 are not inevitable, it is preferred to form these layers for stable performance of the display 15.

The electrode 53 is a transparent electrode made of ITO, IZO or the like. The electrode 54 may be either transparent or opaque. At least the surface of the electrode 54 is made of metal and functions as a reflector. More specifically, if the main material of the electrode 54 is transparent, the surface of the electrode 54 is coated with aluminum or silver so as serve as a reflector. Alternatively, the electrode 54 is wholly made of aluminum, silver or the like.

Further, the back substrate 52 may be transparent, and a reflecting plate may be provided behind the transparent back substrate 52. In this case, however, the substrate 52 shall be made as thin as possible so that the distance between the reflecting plate and the liquid crystal layer will be small.

As the material of the reflecting plate, it is important to use a material which does not offset polarization. Typically, it is preferred to use a material with a metal layer like silver, aluminum or the like.

The electrodes 53 and 54 are connected respectively to a scanning electrode IC and a signal electrode IC (not shown), and specified pulse voltages are applied to the electrodes 53 and 54. In accordance with the voltages applied thereto, the chiral nematic liquid crystal becomes a planar state or a focal-conic state, and thereby, the state of the display changes. The liquid crystal keeps in the state (a planar state or a focal-conic state) after the application of the voltages is stopped, and the liquid crystal has bistability (a memory effect).

The electrode 53 is composed of strips which are parallel to each other at fine intervals, and likewise, the electrode 54 is composed of strips which are parallel to each other at fine intervals. The electrode 53 and the electrode 54 are arranged opposite each other, and the extending direction of the strips of the electrode 53 and the extending direction of the strips of the electrode 54 are perpendicular to each other, viewed from the observing side. Pulse voltages are applied to the upper and lower strips of the electrodes 53 and 54 sequentially. This is called matrix driving, and the intersections between the strips of the electrode 53 and the strips of the electrode 54 serve as pixels.

As the liquid crystal, a kind of liquid crystal which exhibits a cholesteric phase at room temperature is preferably used. Especially, chiral nematic liquid crystal which can be obtained by adding a chiral agent to nematic liquid crystal by an amount sufficient to make the resultant liquid crystal exhibit a cholesteric phase is suited. If the helical pitch is too large, it is difficult to keep the bistability, and the helical pitch is preferably not more than 1000 nm.

Conventional nematic liquid crystal, such as of biphenyl, phenylcyclohexile, tarphenyl, tolane, pyrimidine, stilbene or the like, is usable for the liquid crystal display. Various kinds of conventional chiral agents, such as ester compounds containing optical active radicals such as a cholestrol ring, pyrimidine compounds, azoxy compounds, tolane compounds, etc. are usable.

The liquid crystal layer is preferably prepared so that the retardation Δnd occurring in a focal-conic state will be a quarter of the wavelength λ. In the premise that the circular polarizer is ideal and perfect, the reflectance R of the liquid crystal display in a focal-conic state is calculated as follows:
R=(½){ sin²(2πΔnd/λ)}
An: anisotropy of refractive index in a focal-conic state
d: thickness of the liquid crystal layer

In order to achieve a good black-and-white display, the retardation is preferably adjusted so that the peak of reflectance R will be within the visible spectrum (λ=400 to 700 nm). Especially in order to achieve a good white display (in order to achieve a flat spectral reflectance characteristic within the visible spectrum), it is preferred that Δnd in a focal-conic state is 135±10 nm.

In designing the liquid crystal display 15, the retardation Δnd shall be designed to be slightly larger than 135±10 nm, since the helical axis of the liquid crystal in a focal-conic state is not accurately 0 degree to the substrates (is not accurately parallel to the substrate). For this reason, Δnd of the liquid crystal 15 is preferably designed to be larger so as to compensate the retardation which is reduced due to the fact that the helical axis in a focal-conic state is not 0 degree to the substrates.

In order to set Δnd of the liquid crystal display 15 to 160±10 nm, for example, the anisotropy of refractive index in a focal-conic state Δn and the thickness d of the liquid crystal may be designed as follows:
Δnd=160 nm=0.0320(Δn)×5.0 μm(d)
Δnd=160 nm=0.0400(Δn)×4.0 μm(d)
Δnd=160 nm=0.0457(Δn)×3.5 μm(d)
Δnd=160 nm=0.0533(Δn)×3.0 μm(d)

Also, in order to achieve a good black display, the helical axis in a planar state is ideally 90 degrees to the substrates (retardation Δnd=0 nm). Actually, however, the helical axis in a planar state is not accurately 90 degrees to the substrates and slightly tilts. The degree of the tilt also depends on the thickness d of the liquid crystal layer. According to experiments conducted by the inventors, the smaller the thickness d of the liquid crystal layer is, the smaller the tilt of the helical axis in a planar state is (the closer to 90 degrees to the substrates the helical axis in a planar state is). That is, the smaller the thickness d is, the better black display is obtained.

However, thinning the thickness d of the liquid crystal is accompanied with a difficulty in producing the liquid crystal display 15. Therefore, in view of both display performance and easiness in producing the liquid crystal display, the thickness d of the liquid crystal layer is desirably within a range from 3.0 μm to 4.5 μm, more desirably within a range from 3.0 μm to 4.0 μm and further more desirably within a range from 3.0 μm to 3.5 μm.

Further, in order to maintain the gap between the substrates 51 and 52, spacers of an inorganic material and/or a columnar structure (not shown) of an organic material are provided in the liquid crystal. However, instead of adopting this structure, the liquid crystal layer may be made as a liquid crystal composite layer of a so-called polymer-dispersed type, in which liquid crystal is dispersed in a conventional three-dimensional polymer net or in which a three-dimensional polymer net is formed in liquid crystal.

The scattering layer 14 is a transparent substrate in which fine particles with different refractive indexes are dispersed. The scattering layer 14 may be a film or may be a sticky film. As the transparent substrate, polyether sulfone (PES), polycarbonate (PC), triacetyl cellulose (TAC), etc. can be used. As the fine particles, spherical fine particles of, for example, acrylic resin, silica or the like can be used. Alternatively, the surface of the substrate may be roughened so that the substrate will have a scattering function.

The scattering layer 14 scatters incident light and reflected light passing therethrough moderately and weakens the directivity of the reflection made by the electrode 54. The scattering layer 14 also does not offset the polarization, and accordingly, the scattering layer 14 does not lower the contrast. When the liquid crystal is in a focal-conic state, the light reflected by the electrodes 54 transmits the liquid crystal layer and becomes circularly polarized light. At this time, the directivity of the reflected light (circularly polarized light) is eased, and a good white display (paper white) can be achieved.

An important factor of the scattering layer 14 is haze. The haze is adjustable to any desirable value by adjusting the diameters and the dispersing density of the fine particles. In order to achieve a good contrast between black and white, the haze is desirably within a range from 10% to 85%, and more desirably within a range from 30% to 70%. As will be apparent from Table 1 later, if the haze is too small, influence of the directivity of the reflector is apt to remain, resulting in a poor white display. If the haze is too large, the polarization will be offset, resulting in a poor black display. Thus, the contrast will be lower.

The circular polarizer 11 is composed of a linear polarizer 12 and a retardation film 13. A conventional linear polarizer and a conventional quarter-wavelength retardation film can be used. The circular polarizer 11 can be fabricated by stacking the linear polarizer and the retardation film in such a way that the respective optical axes cross at 45 degrees or at 135 degrees to each other.

In this structure, however, the circular polarizer 11 is not a perfect circular polarizer. Specifically, the circular polarizer 11 serves as a perfect circular polarizer toward light of only a specified wavelength within the visible spectrum and serves as an elliptic polarizer toward visible light of the other wavelengths. In order to fabricate an ideal circular polarizer, it is necessary to stack a plurality of retardation films. However, using many retardation films is costly, and for this reason, the number of retardation films is preferably three at most. It is the best to use only one retardation film which permits a practically sufficient display performance while minimizing the cost.

Circular polarizers are classified into clockwise circular polarizers (the light passing therethrough is clockwise polarized) and counterclockwise circular polarizers (the light passing therethrough is counterclockwise polarized). According to the preferred embodiment, in order to achieve a good black-and-white display, the circular polarizer 11 is preferably a circular polarizer which transmits light which has been circularly polarized in such a direction as not to be reflected by the liquid crystal layer.

When a display of white and another color (for example, a white-and-blue display) is to be made by using selective reflection in a planar state also, the circular polarizer 11 should be a circular polarizer which transmits light which has been circularly polarized in such a direction as to be reflected by the liquid crystal layer.

In driving the liquid crystal display apparatus 1A, for example, a three-stage method, in which a pulse voltage comprising a reset step, a selection step and an evolution step is applied to the electrodes 53 and 54, can be adopted. In the following second and third embodiments, the same method can be adopted.

### Second Embodiment; See FIG. 6

FIG. 6 shows a liquid crystal display apparatus 1B according to the second embodiment. The liquid crystal display apparatus 1B comprises a circular polarizer 11 (composed of a linear polarizer 12 and a retardation film 13) and a liquid crystal display 15 which are stacked in this order from the observing side. The liquid crystal display 15 has a substrate 51′ which is made of a transparent material. Fine particles are dispersed in the transparent material, so that the substrate 51′ functions also as a scattering layer like the above-described scattering layer 14. Thereby, when the liquid crystal is in a focal-conic state, a good white display (paper white) can be achieved, and the contrast will not become lower substantially.

The other parts of the liquid crystal display 1B are of the same structures of those of the liquid crystal display 1A according to the first embodiment. In FIG. 6, the same parts and the same members are provided with the same reference numbers as in FIG. 5, and descriptions of these parts and members are omitted.

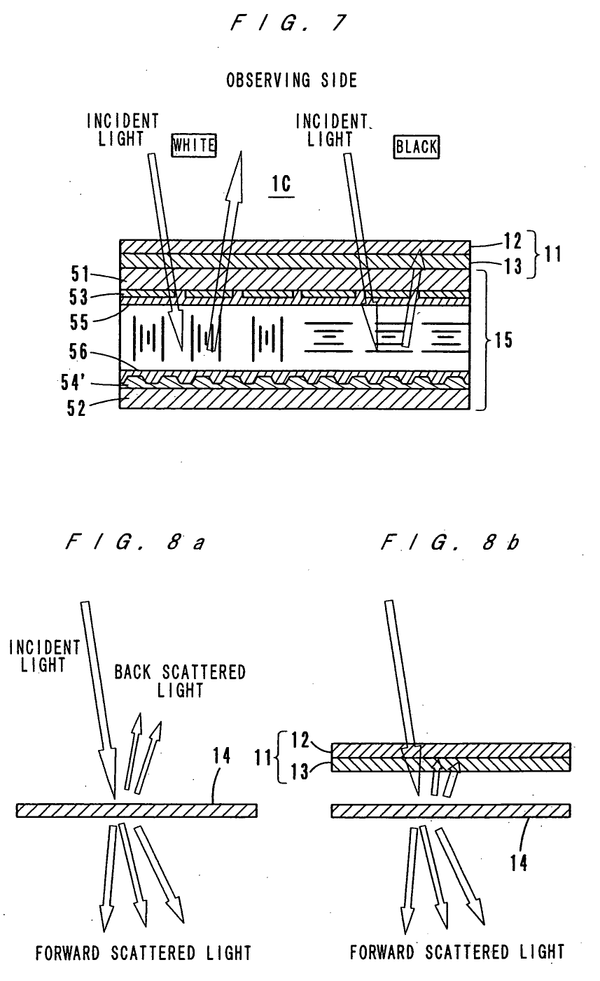

### Third Embodiment; See FIG. 7

FIG. 7 shows a liquid crystal display apparatus 1C according to the third embodiment. The liquid crystal display apparatus 1C comprises a circular polarizer 11 (composed of a linear polarizer 12 and a retardation film 13) and a liquid crystal display 15 which are stacked in this order from the observing side. The liquid crystal display 15 has a substrate 52 with an electrode 54′ formed thereon. The electrode 54′ has an uneven surface in the observing side, so that the electrode 54′ functions as a reflector and also functions to weaken the directivity of reflected light like the above-described scattering layer 14. Thereby, when the liquid crystal is in a focal-conic state, a good white display (paper white) can be achieved, and the contrast will not become lower substantially.

The other parts of the liquid crystal display 1C are of the same structures of those of the liquid crystal display 1A according to the first embodiment. In FIG. 7, the same parts and the same members are provided with the same reference numbers as in FIG. 5, and descriptions of these parts and members are omitted.

In the third embodiment, in forming the electrode 54′ with an uneven surface, for example, the following method can be adopted; a resist is coated on, for example, a glass substrate 52; the resist is patterned to be finely uneven by photolithography; and thereafter, a conductive reflecting metal material is sputtered on the uneven surface of the substrate.

### Position of the Scattering Layer; See FIG. 8

The scattering layer 14 is preferably arranged on the lower surface (the surface farther from the observing side) of the circular polarizer 11. As FIG. 8a shows, when light is incident to a scattering layer, forward scattered light and back scattered light are generated. Due to the back scattered light, a black display is degraded, that is, the back scattered light causes a lowering of the contrast. When the scattering layer 14 is provided on the lower surface of the circular polarizer 11 as shown by FIG. 8b, however, the back scattered light is absorbed in the circular polarizer 11, and a lowering of the contrast can be prevented.

Also, the scattering layer 14 is preferably provided as close as possible to the liquid crystal layer. If the scattering layer 14 is located at a too large distance from the liquid crystal layer, due to scattering, lights reflected from a plurality of pixels are mixed together and are incident to an observer's eyes, and to the observer, the resolution seems lower. From this viewpoint, the second embodiment in which the substrate 51 has a scattering function and the third embodiment in which the electrode 54′ has a scattering function are preferable. In the first embodiment in which the scattering layer 14 is provided, the substrate 51 located between the scattering layer 14 and the liquid crystal should be as thin as possible. More specifically, it is preferred that the gap between the scattering layer and the liquid crystal is not more than 0.5 mm. When a film substrate is used as the substrate 51, it is easy to make a gap of not more than 0.5 mm between the scattering layer and the liquid crystal. When a glass substrate is used as the substrate 51, after finishing fabrication of the liquid crystal cell with filling a liquid crystal layer therein, the substrate 51 can be polished so as to be thinner.

### EXAMPLE 1

The liquid crystal display apparatus 1A according to the first embodiment shown in FIG. 5 was fabricated by using the following materials. As the substrate 51 in the observing side, a glass substrate with a thickness of 1.0 mm was used, and the electrode 53 was formed of ITO thereon. As the back substrate 52, a glass substrate with a thickness of 1.0 mm was used, and the electrode 54 was formed of Al thereon. The electrode 54 also served as a reflector. In forming the electrodes 53 and 54, ITO and Al were sputtered on the surfaces of the respective glass substrates, and electrode patterns were formed by photolithography. As the aligning layers 55 and 56, a horizontal aligning film AL8044 (made by JSR Co., Ltd.) was printed on the electrode sides of the respective substrates 51 and 52 by flexography.

As the liquid crystal, nematic liquid crystal and a chiral agent were mixed in such a way that the resultant liquid crystal would exhibit a cholesteric phase at room temperature. The resultant liquid crystal had the following properties: anisotropy of refractive index Δn=0.052; anisotropy of dielectric constant Δε=13.09; and helical pitch P=263 nm. The helical structure was so formed that the liquid crystal would selectively reflect clockwise polarized light. The thickness of the liquid crystal layer (the gap between the substrates) was approximately 3 μm, and Micropearl SP-203 (made by Sekisui Finechemical, Co., Ltd.) was used as a gap controller.

As the scattering layer 14, a front diffuser film was used.

As the linear polarizer 12 of the circular polarizer 11, EG1425DU (made by Nitto Denko Co., Ltd.) was used, and as the retardation film 13 of the circular polarizer 11, R-140 (PC uniaxial oriented film made by Nitto Denko Co., Ltd.) was used. The linear polarizer 12 and the retardation film 13 were arranged in such a way that the absorption axis of the linear polarizer 12 and the lag axis of the retardation film 13 would be at 45 degrees to each other so that light passing through the circular polarizer 11 would become counterclockwise polarized light (which the cholesteric liquid crystal would not selectively reflect).

By using the liquid crystal display apparatus fabricated as the Example 1, an experiment on the relationship between the haze of the scattering layer 14 and the contrast was conducted. Specifically, in respective cases of using scattering layers with a haze of 0%, with a haze of 8%, with a haze of 10%, with a haze of 30%, with a haze of 50%, with a haze of 70%, with a haze of 85% and with a haze of 90%, the white display and the contrast were evaluated. Table 1 shows the results.

TABLE 1

| Haze | White Display | Contrast |
|---|---|---|
| 0% | X | 9.0 |
| 8% | Δ | 8.2 |
| 10% | ∘ | 8.0 |
| 30% | ⊚ | 7.5 |
| 50% | ⊚ | 7.5 |
| 70% | ⊚ | 6.5 |
| 85% | ⊚ | 5.0 |
| 90% | ⊚ | 3.5 |

A white display was inspected by the eye and evaluated in three grades. More specifically, the mark ⊙ indicates that the white display was seen as paper white and was evaluated excellent. The mark ◯ indicates that the white display was evaluated as a good white display although being worse than a display marked with ⊙. The mark Δ indicates that the white display was evaluated as a fair (practically tolerable) white display although being worse than a display marked with ◯. The mark x indicates that the white display was not evaluated as paper white due to too strong directivity of the reflected light.

The contrast was measured by a spectro-colorimeter CM3700 (made by Konica Minolta Co., Ltd.) in a mirror reflection eliminating mode.

According to the results of the experiment, by providing a scattering layer with an appropriate haze, a good white display (paper white) could be achieved. The larger the haze of the scattering layer was, the less directivity the white display had, and it was inspected by the eye that a scattering layer with a haze not less than 10% permitted a good white display.

On the other hand, a scattering layer with a haze over 85%, the contrast became lower. In order to obtain good visibility of a display, the contrast is preferably 5 or more. Therefore, in order to obtain a good white display and a good contrast, the haze of the scattering layer shall be within a range from 10% to 85% and desirably, within a range from 30% to 70%.

### EXAMPLE 2

The liquid crystal display apparatus 1A according to the first embodiment shown in FIG. 5 was fabricated by using the following materials. As the substrate 51 in the observing side, a PES film with a thickness of 0.1 mm was used, and the electrode 53 was formed of ITO thereon. As the back substrate 52, a PES film with a thickness of 0.1 mm was used, and the electrode 54 was formed of Al thereon. The electrode 54 also served as a reflector. In forming the electrodes 53 and 54, ITO and Al were sputtered on the surfaces of the respective film substrates, and electrode patterns were formed by photolithography. As the aligning layers 55 and 56, a horizontal aligning film AL8044 (made by JSR Co., Ltd.) was printed on the electrode sides of the respective substrates 51 and 52 by flexography.

A resin material, of which main content was thermoplastic resin, was deposited on a metal mask, in which a large number of holes with a diameter of 100 μm were formed, and screen printing was performed by using a squeegee. In this way, a polymer columnar structure with a height slightly higher than 3 μm was formed.

In liquid crystal with the same composition and the same properties as the liquid crystal used in Example 1, spherical spacers with a particle diameter of 3 μm were contained, and the resultant liquid crystal was coated on the substrate 51. Thereafter, the substrates 51 and 52 were laminated and heated at approximately 150° C. for one hour, and thus, a liquid crystal display 15 was fabricated. This liquid crystal display 15, the scattering layer 14 used in Example 1 and the circular polarizer 11 (composed of a linear polarizer 12 and a retardation film 13) used in Example 1 were stacked, and thus, a liquid crystal display apparatus was fabricated.

By using this liquid crystal display apparatus of Example 2, an experiment on white display and contrast was conducted. The results were like the results shown by Table 1. Further, in Example 2, since a thin film substrate was used as the substrate 51, the distance between the scattering layer 14 and the liquid crystal layer is small, and a sharp display without blur could be achieved. In a high-accuracy display of 100 dpi, the respective pixels could be distinguished from one another.

### EXAMPLE 3

A liquid crystal display apparatus 1C according to the third embodiment shown by FIG. 7 was fabricated basically in the same way of forming the above-described Example 1. In Example 3, however, the scattering layer 14 was not provided, and instead, a scattering function was imparted to the Al electrode 54′ serving also as a reflector and formed on the back substrate 52. The other structures and materials were the same as those of Example 1.

The electrode 54′ was formed in the following way: a resist was coated on the glass substrate 52; the resist was patterned so as to have an uneven surface by photolithography; and Al was sputtered on the uneven surface of the substrate.

By using the liquid crystal display apparatus of Example 3, an experiment on the white display and the contrast was conducted. The results were like the results shown by Table 1. In Example 3, since the distance between the electrode 54′ with a scattering function and the liquid crystal layer is small, a sharp display without blur could be achieved.

### Other Embodiments

The composition and the properties of the cholesteric liquid crystal can be arbitrary designed, and various kinds of methods of driving the liquid crystal can be adopted.

Although the present invention has been described in connection with the preferred embodiments above, it is to be noted that various changes and modifications are possible to those who are skilled in the art. Such changes and modifications are to be understood as being within the scope of the present invention.

1. A reflective-type liquid crystal display apparatus comprising:
a polarizer;
a cholesteric liquid crystal layer which changes between a planar state and a focal-conic state depending on a voltage applied thereto;
a reflecting plate; and
a scattering layer.

2. A reflective-type liquid crystal display apparatus according to claim 1, wherein the scattering layer has a haze within a range from 10% to 85%.

3. A reflective-type liquid crystal display apparatus according to claim 1, wherein the scattering layer has a haze within a range from 30% to 85%.

4. A reflective-type liquid crystal display apparatus according to claim 1, wherein the scattering layer has a haze within a range from 30% to 70%.

5. A reflective-type liquid crystal display apparatus according to claim 1, wherein:
the polarizer comprises a linear polarizer and a retardation film; and
the scattering layer is located on a lower side of the polarizer.

6. A reflective-type liquid crystal display apparatus according to claim 1, wherein the scattering layer is located at a distance not more than 0.5 mm from the cholestric liquid crystal layer.

7. A reflective-type liquid crystal display apparatus according to claim 6, wherein:
the cholesteric liquid crystal layer is supported between a pair of substrates; and
the substrate located between the cholesteric liquid crystal layer and the scattering layer is a film substrate.

8. A reflective-type liquid crystal display apparatus according to claim 1, wherein:
the cholesteric liquid crystal layer is supported between a pair of substrates; and
the substrate located closer to an observing side serves as a scattering layer.

9. A reflective-type liquid crystal display apparatus comprising:
a polarizer;
a cholesteric liquid crystal layer which changes between a planar state and a focal-conic state depending on a voltage applied thereto; and
a reflecting plate which has an uneven surface serving as a scattering reflecting surface.

10. A reflective-type liquid crystal display apparatus according to claim 9, wherein the reflecting plate is an electrode used to apply a voltage to the cholesteric liquid crystal layer.
